(19) United States
(12) Patent Application Publication
(10) Pub. No.: US 2025/0084496 A1
(43) Pub. Date: Mar. 13, 2025

(54) PROCESSING GRANULATED METALLIC UNITS WITHIN ELECTRIC ARC FURNACES, AND ASSOCIATED SYSTEMS AND METHODS

(71) Applicant: SUNCOKE TECHNOLOGY AND DEVELOPMENT LLC, Lisle, IL (US)

(72) Inventors: John Francis QUANCI, Haddonfield, NJ (US); John Michael RICHARDSON, Devon, PA (US); Patrick James MULLARKEY, Manhattan, IL (US); David James SCHWAKE, Aurora, IL (US); Andrew Michael BUTOR, Cranberry Township, PA (US); Jonathan Hale PERKINS, Lisle, IL (US); Chun Wai CHOI, Lisle, IL (US)

(21) Appl. No.: 18/882,501

(22) Filed: Sep. 11, 2024

Related U.S. Application Data
(60) Provisional application No. 63/581,946, filed on Sep. 11, 2023.

(51) Int. Cl. C21C 5/52; B22F 1/05; C22C 38/00; C22C 38/02; C22C 38/04

(52) U.S. Cl. CPC C21C 5/52; B22F 1/05; C22C 38/002; C22C 38/02; C22C 38/04; B22F 2301/35; B22F 2304/15; B22F 2999/00

(57) ABSTRACT

Processing granulated metallic units within electric arc furnaces (EAFs) and associated systems, devices, and methods are disclosed herein. A representative method can include receiving granulated metallic units in an EAF, wherein the granulated metallic units comprise no more than 0.05 wt. % of sulfur and at least 50% of particles in the granulated iron material have a particle size of at least 6 millimeters. The method can include applying electrical energy to the granulated iron via electrodes and melting the granulated iron material to form a molten steel product. The method can also include tapping the EAF to remove the molten steel product from the EAF.

### CROSS-REFERENCE TO RELATED APPLICATIONS

The present application claims the benefit of U.S. Provisional Patent Application No. 63/581,946, filed Sep. 11, 2023, and titled “SYSTEM AND METHOD FOR CONTINUOUS GRANULATED PIG IRON (GPI) PRODUCTION,” the disclosure of which is incorporated herein by reference in its entirety. The present application is related to the following applications, the disclosures of which are incorporated herein by reference in their entireties: U.S. patent application Ser. No. 18/882,116 [Attorney Docket No. 084553.8072.US00], filed Sep. 11, 2024, and titled “RAILCARS FOR TRANSPORTING GRANULATED METALLIC UNITS, AND ASSOCIATED SYSTEMS, DEVICES, AND METHODS”; U.S. patent application Ser. No. 18/882,045 [Attorney Docket No. 084553.8073.US00], filed Sep. 11, 2024, and titled “LOADING GRANULATED METALLIC UNITS INTO RAILCARS, AND ASSOCIATED SYSTEMS, DEVICES, AND METHODS”; U.S. patent application Ser. No. 18/882,191 [Attorney Docket No. 084553.8074.US00], filed Sep. 11, 2024, and titled “LOW-SULFUR GRANULATED METALLIC UNITS, AND ASSOCIATED SYSTEMS, DEVICES, AND METHODS”; U.S. patent application Ser. No. 18/882,638 [Attorney Docket No. 084553.8075.US00], filed Sep. 11, 2024, and titled “CONTINUOUS GRANULATED METALLIC UNITS PRODUCTION, AND ASSOCIATED SYSTEMS, DEVICES, AND METHODS”; U.S. patent application Ser. No. 18/882,661 [Attorney Docket No. 084553.8076.US00], filed Sep. 11, 2024, and titled “USE OF A BASIC OXYGEN FURNACE TO PRODUCE GRANULATED METALLIC UNITS, AND ASSOCIATED SYSTEMS, DEVICES, AND METHODS”; U.S. patent application Ser. No. 18/882,256 [Attorney Docket No. 084553.8077.US00], filed Sep. 11, 2024, and titled “LOW-CARBON GRANULATED METALLIC UNITS, AND ASSOCIATED SYSTEMS, DEVICES, AND METHODS”; U.S. patent application Ser. No. 18/882,531 [Attorney Docket No. 084553.8078.US00], filed Sep. 11, 2024, and titled “TORPEDO CARS FOR USE WITH GRANULATED METALLIC UNITS PRODUCTION, AND ASSOCIATED SYSTEMS, DEVICES, AND METHODS”; U.S. patent application Ser. No. 18/882,384 [Attorney Docket No. 084553.8079.US00], filed Sep. 11, 2024, and titled “TREATING COOLING WATER IN IRON PRODUCTION FACILITIES, AND ASSOCIATED SYSTEMS, DEVICES, AND METHODS”; U.S. patent application Ser. No. 18/882,465 [Attorney Docket No. 084553.8080.US00], filed Sep. 11, 2024, and titled “USE OF RESIDUAL IRON WITHIN GRANULATED METALLIC UNITS PRODUCTION FACILITIES, AND ASSOCIATED SYSTEMS, DEVICES, AND METHODS”.

### TECHNICAL FIELD

This present technology relates to granulated iron materials and electric arc furnace systems and methods of processing such.

### BACKGROUND

Granulated pig iron (GPI) is a form of pig iron that is granulated into small, uniform particles, making it easier to handle, transport, and use in different metallurgical processes compared to conventional pig iron. The demand for GPI has been steadily increasing due to its versatile applications in various industries, including automotive, construction, and manufacturing. The growing popularity of GPI can be attributed to its high purity, consistent quality, and the efficiency it brings to the production of steel and other iron-based products.

Granulated pig iron is produced by rapidly cooling molten pig iron with water, resulting in the formation of granules. This process, known as granulation, is typically carried out in blast furnaces. However, current production methods are often characterized by intermittent production cycles due to various operational constraints, such as the need for periodic maintenance, fluctuations in raw material supply, and energy consumption issues. These interruptions not only affect the overall efficiency but also lead to increased production costs and variability in product quality. Therefore, there is a need for an improved production process that can ensure continuous and stable granulation of pig iron, thereby enhancing productivity and reducing operational costs.

### BRIEF DESCRIPTION OF THE DRAWINGS

Features, aspects, and advantages of the presently disclosed technology may be better understood with regard to the following drawings.

FIG. 1 is a schematic block diagram of a continuous GMU production system configured in accordance with embodiments of the present technology.

FIG. 2 is a plan view of the continuous GMU production system of FIG. 1, configured in accordance with embodiments of the present technology.

FIG. 3 is an enlarged view of the continuous GMU production system of FIG. 2.

FIG. 4 is a partially schematic illustration of an EAF system, in accordance with embodiments of the present technology.

FIG. 5 is a flow diagram of a method for producing GMUs, in accordance with embodiments of the present technology.

FIG. 6 is a chart depicting Particle Size vs. Cumulative Percentage of GMUs, in accordance with embodiments of the present technology.

FIG. 7 is a flow diagram of a process of producing steel from GMUs by an electric arc furnace system, in accordance with embodiments of the present technology.

A person skilled in the relevant art will understand that the features shown in the drawings are for purposes of illustrations, and variations, including different and/or additional features and arrangements thereof, are possible.

### DETAILED DESCRIPTION

### I. Overview

High-quality steel is used in various industries, including construction, automotive, aerospace, and manufacturing, and a widely used method for producing high-quality steel is through the use of an Electric Arc Furnace (EAF). EAFs are highly efficient in melting a wide variety of iron products, including recycled scrap steel, and converting it into steel products, which helps in reducing waste and conserving natural resources. EAFs allow for the production of specialty steels with specific properties, such as high-strength, low-alloy steels, stainless steels, and tool steels. Granulated iron is used as an input material for steel in EAF processes. Using granulated iron as feed in an EAF enhances the steelmaking process by providing consistent quality and improving melting efficiency. This can lead to higher-quality steel with better mechanical properties and lower energy consumption. The EAF process provides flexibility in raw material usage, energy efficiency, and the ability to produce steel with precise compositions. However, the production of high-quality steel by EAF requires effective refining and impurity removal processes that can decrease the efficiency and increase the cost of steel production.

Impurities (e.g., sulfur, phosphorus, silicon) of the granulated iron in the EAF steelmaking can negatively affect the quality and properties of the final steel product. Phosphorus, silicon, and sulfur can reduce ductility and toughness, cause brittleness, and lead to surface defects and weldability issues. These impurities also contribute to the formation of non-metallic inclusions and excessive slag, complicating the steelmaking process and compromising the quality of the final steel product. Further, sulfur can accelerate the wear and erosion of refractory linings of furnace shells thereby increasing the maintenance and decreasing the lifetime of EAFs. Impurities can be removed in the EAF process through the addition of desulfurizing agents, basic fluxes, and deoxidizing agents, which form compounds that are captured in the slag and separated from the molten steel. Removal of impurities to acceptable levels increases the cost and decreases the efficiency of the steelmaking process. Further, in order to achieve the desired steel composition and properties, the EAF processes include carbon removal. For example, in some implementations, steel is required to have a carbon concentration varying below 4 wt. % depending on the end-use of the steel while granulated iron used as a starting material has a carbon concentration above 4 wt. %. Carbon removal is a time-consuming step in the steelmaking process.

Embodiments of the present technology address at least some of the above-described issues by providing granulated metallic units (GMUs) for EAF steelmaking. For example, embodiments of the present technology include GMUs having a sulfur concentration of less than or equal to 0.05 wt. % (e.g., less than or equal to 0.01 wt. %, less than 0.005 wt. %, less than 0.003 wt. % of sulfur). In some embodiments, the GMUs can have low concentrations of other impurities as well (e.g., 0.01 wt. % to 0.1 wt. % of phosphorus, 0.1 wt. % to 2 wt. % of silicon, and 0.1 wt. % to 1.0 wt. % of manganese). Further, the GMUs can have a particle size distribution that provides a balance between melting efficiency, charge density, dust generation, and slag formation. For example, in some embodiments, at least 50% of particles in the GMUs have a particle size between 8 and 16 millimeters. The GMUs of the present technology can enable the production of high-quality steel with better cost-effectiveness because similar or better-quality steel can be produced without any, or with reduced, impurity removals (e.g., via desulfurization).

Embodiments of the present technology can include GMUs having different ranges of carbon that can be used for making steel of desired carbon concentration without a need for carbon removal. In some embodiments, the GMUs can comprise one or more of granulated pig iron (GPI) particles having a concentration of more than 4 wt. % of carbon, granulated iron (GI) particles having a concentration of 1 to 4 wt. % (e.g., 1 to 3% or 1 to 2%) of carbon, or granulated steel (GS) particles having a concentration of less than 1 wt. % of carbon or a combination thereof. The present technology provides for an efficient and lower-cost process for making high-quality steel by EAF with the high-purity granulated carbon, described above. Additional benefits of embodiments of the present technology are described elsewhere herein.

In the Figures, identical reference numbers identify generally similar, and/or identical, elements. Many of the details, dimensions, and other features shown in the Figures are merely illustrative of particular embodiments of the disclosed technology. Accordingly, other embodiments can have other details, dimensions, and features without departing from the spirit or scope of the disclosure. In addition, those of ordinary skill in the art will appreciate that further embodiments of the various disclosed technologies can be practiced without several of the details described below.

The disclosed granulated metallic units production system is designed for continuous operation. Relative to non-continuous GMU production systems, embodiments of the present technology enhance energy efficiency and reduce emissions by minimizing the need for frequent shutdowns and restarts, which are often associated with excessive venting and/or less efficient operations. As described herein, some embodiments include (i) a desulfurization unit that lowers the sulfur content in molten metal, thereby reducing sulfur dioxide (SO₂) emissions, (ii) dust collection units that filter out particulate matter, thereby reducing air pollution, (iii) infrastructure to recycle fines, slag, iron skulls and other residual iron/previously-processed iron, thereby reducing the environmental impact associated with raw material extraction and conserving natural resources, and/or (iv) water management and cooling systems that minimize heat losses, enhance the thermal efficiency of production processes, and optimize water consumption. Overall, the continuous GMU production system enhances productivity while minimizing greenhouse gas emissions and waste, contributing to more sustainable industrial practices and helping mitigate climate change.

Relatedly, conventional iron production has a significant environmental impact due to its high energy consumption and emissions of pollutants. As such, embodiments of the present technology which relate to GMU production systems can reduce this impact. Sulfur, phosphorus, and silicon in GMU negatively affect the quality and properties of final metal products, leading to issues like reduced ductility, toughness, and weldability, as well as surface defects and brittleness. These impurities also contribute to the formation of non-metallic inclusions and excessive slag, complicating metal processing and compromising product quality. Sulfur, in particular, accelerates the wear and erosion of metal processing equipment, increasing maintenance costs and decreasing equipment lifespan. Embodiments of the present technology include methods for removing these impurities in part can improve the quality and durability of final metal products and enhance the efficiency and lifespan of processing equipment, leading to cost savings and more sustainable production practices.

Further, the disclosed technology is directed to the production of steel from a high-purity, low-sulfur and low-carbon GMU. A representative method can include receiving GMUs in an EAF, where the GMUs comprise, for example, no more than 0.05 wt. % of sulfur and below 4% of carbon. The method can include applying electrical energy to the granulated iron via electrodes and melting the GMUs to form a molten steel product. The method can also include tapping the EAF to remove the molten steel product from the EAF. The low sulfur and carbon content can result in reduced sulfur oxides and carbon dioxide emissions compared to the production of steel using conventional materials, thereby reducing the contribution of sulfur oxides and carbon dioxide to air pollution and acid rain.

### I. Embodiments of a Continuous Granulated Metallic Unit Production System

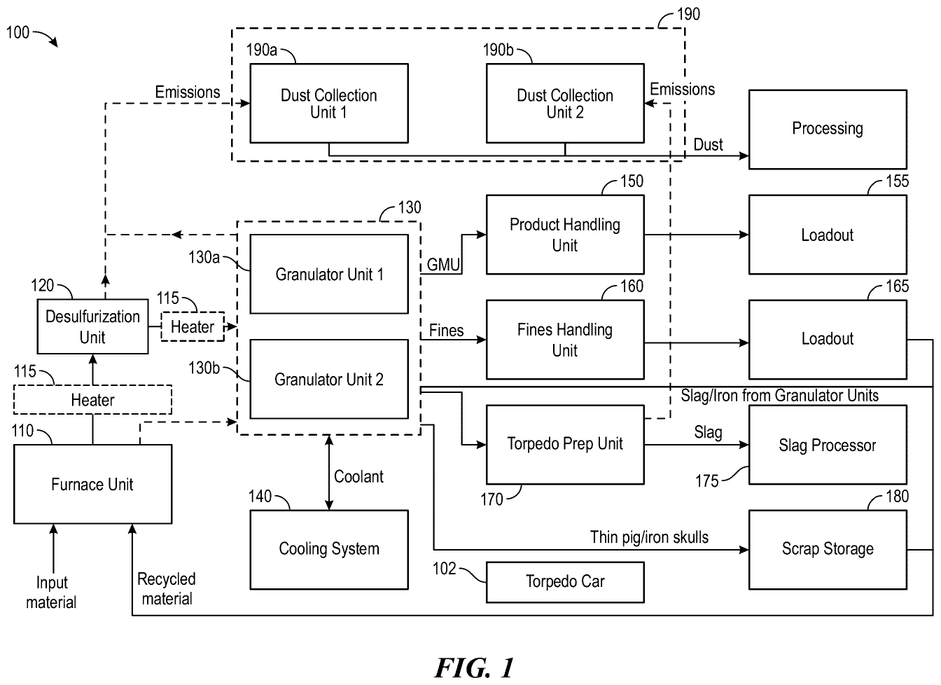

FIG. 1 is a schematic block diagram of a continuous GMU production system 100 (“the system 100”) configured in accordance with embodiments of the present technology. As explained elsewhere herein, GMUs can include granulated iron (GI), granulated pig iron (GPI), granulated steel (GS), or GMU. Relatedly, molten metal can include molten pig iron or molten steel. As used herein, the term “continuous” should be interpreted to mean continuous operations cycles, including in batch or semi-batch operations, for at least 4 hours, 6 hours, 8 hours, 10 hours, 12 hours, 16 hours, 20 hours, or 24 hours. The system 100 can include a furnace unit 110, a desulfurization unit 120, granulator units 130 including a first granulator unit 130a and a second granulator unit 130b, and a cooling system 140. The furnace unit 110 can receive input materials (e.g., iron ore, coke, limestone, and/or preheated air) and/or recycled material, which can be sourced from downstream components of the system 100 as described in further detail herein. Equations (1)-(6) below detail some of the chemical processes controlled at the furnace unit.

C+O₂→CO₂ (1)

CO₂+C→2CO (2)

Fe₂O₃+3CO→2Fe+3CO₂ (3)

Fe₂O₃+3C→2Fe+3CO (4)

CaCO₃→CaO+CO₂ (5)

CaO+SiO₂→CaSiO₃ (6)

Equation (1) represents the combustion of coke, which is a form of carbon. When coke reacts with oxygen gas introduced into the furnace (e.g., via an oxygen lance), it forms carbon dioxide. This exothermic reaction releases a significant amount of heat, which is essential for maintaining the high temperatures required for subsequent reactions. The carbon dioxide produced via Equation (1) further reacts with additional coke to form carbon monoxide, as illustrated by Equation (2). This endothermic reaction helps to moderate the temperature within the furnace unit 110. Equations (3) and (4) represent the reduction of iron ore (Fe₂O₃). As illustrated by Equation (3), the iron oxide reacts with the carbon monoxide produced via Equation (2), which acts as a reducing agent to convert iron ore into iron and produces carbon dioxide as a byproduct. Alternatively, as illustrated by Equation (4), the iron ore may be reduced directly by the coke, albeit less commonly. Equations (5) and (6) represent the formation of slag. As illustrated by Equation (5), the calcium carbonate/limestone (CaCO₃) can decompose into calcium oxide and carbon dioxide at the high temperatures of the furnace unit 110. As illustrated by Equation (6), the calcium oxide can then react with silica (SiO₂), an impurity in the iron ore, to form calcium silicate (CaSiO₃), also known as slag. The furnace unit 110 can output molten iron (from Equations (3) and (4)) and slag (from Equations (5) and (6)).

In some embodiments, the input materials (e.g., the coke, the iron ore, and/or the limestone) include sulfur, which can remain in the molten iron output by the furnace unit 110. A torpedo car 102 or other transfer vessel can transfer the molten iron from the furnace unit 110 to the desulfurization unit 120. The desulfurization unit 120 can include equipment to reduce the sulfur content of the molten iron. For example, one or more lances can be used to deliver magnesium (Mg), calcium carbide (CaC₂), or other sulfur-reducing agent to the molten iron. In some embodiments, the molten iron is desulfurized while remaining inside the torpedo car 102. Equations (7) and (8) below detail the reactions between the sulfur and the sulfur-reducing agents.

Mg+S→MgS (7)

CaC₂+S→CaS+2C (8)

The resulting substances, including magnesium sulfide (MgS) and calcium sulfide (CaS), are not soluble in molten iron and will therefore be in solid form (e.g., as solid particles) that can be more readily removed at the desulfurization unit 120 and/or further downstream. As discussed further herein, reducing the sulfur content can increase the quality of the GMU product and/or allow the production process to be continuous. After the desulfurization process, the torpedo car 102 can transfer the molten iron from the desulfurization unit 120 to the granulator units 130. In some embodiments, as indicated by the dashed arrow, the desulfurization unit 120 is bypassed and the molten iron is transferred directly from the furnace unit 110 to the granulator units 130. Notably, conventional facilities may not include a desulfurization unit or may otherwise lack the ability to desulfurize molten iron. One reason for this is that conventional steelmaking facilities directly feed molten iron from blast furnaces to basic oxygen furnaces, and opt to granulate the molten iron only when the basic oxygen furnaces are down. Because producing GMU is a backup operation for such facilities, the added complexity and costs associated with establishing desulfurization equipment may not be economical.

In some embodiments, the temperature of the molten iron is within a predetermined range prior to reaching the granulator units 130. For example, maintaining the molten iron in a sufficiently fluid state can better ensure the formation of uniform granules and help avoid premature solidification, which can lead to irregular granule shapes and sizes. In some embodiments, the system includes one or more heaters 115 before and/or after the desulfurization unit 120, e.g., to reheat the molten iron within the torpedo car 102. For example, if the temperature of the molten iron is below a threshold temperature value, the heater 115 can be used to raise the temperature of the molten iron in the torpedo car 102 to be within a desired temperature range. The threshold temperature value can vary between different compositions, and can be between 2300-2500° F., between 2300-2400° F., or between 2340-2350° F. In some embodiments, the heater 115 comprises one or more oxygen lances.

The torpedo car 102 can transfer the molten iron to one of the granulator units 130. While FIG. 1 illustrates two granulator units 130, it will be understood that the system 100 can include one, three, four, five, six, or more granulator units 130. The granulator units 130 can each include a granulation reactor that receives and granulates molten iron to form granulated products. For example, the granulation reactor can include a cavity that holds water, and the molten iron can be transferred (e.g., poured, sprayed) onto a target of the reactor holding the water. The water can be maintained at a sufficiently low temperature by the cooling system 140 (e.g., cooled directly by pumping the water between the granulator units 130 and the cooling system 140, cooled indirectly by pumping a coolant separate from the water that receives the molten iron). In some embodiments, the granulator units 130 each includes one or more components for controlling the flow of molten iron from the torpedo car 102 to the granulation reactor. As one of ordinary skill in the art will appreciate, flow control can affect the shape, size, and quality of the granulated products. The granulator units 130 can also include a dewatering assembly for drying the granulated products from the granulation reactor to output GMU. The granulator units 130 can further include a classifier assembly for filtering the filtrate from the dewatering assembly to output fines.

The system 100 can further include a product handing unit 150 to receive the GMU output by the granulator units 130 (e.g., by the dewatering assembly), and a loadout 155 downstream of the product handling unit 150. Additionally, the system 100 can further include a fines handling unit 160 to receive the fines output by the granulator units 130 (e.g., by the classifier assembly), and a loadout 165 downstream of the fines handling unit 160. In some embodiments, the product handling unit 150 and/or the fines handling unit 160 each includes one or more conveyor belts, diverters, stockpile locations, etc. The system 100 can additionally include a torpedo preparation unit 170 that can remove slag and/or kish from the torpedo car 102. For example, the torpedo car 102, after delivering the molten iron to the granulator units 130, can proceed to the torpedo prep unit 170 to be cleaned or otherwise prepared for the next cycle of transferring molten iron. The removed slag can be subsequently transferred to a slag processor 175. The system 100 can further include a scrap storage 180 that can receive thin pig and/or iron skulls from the granulator units 130.

As shown in FIG. 1, the fines at the loadout 165, slag and/or iron from the granulator units 130, and/or the thin pig and/or iron skulls at the scrap storage 180 can be fed back into the furnace unit 110 as recycled materials. In some embodiments, the recycled materials are processed (e.g., pelletized) prior to being fed into the furnace unit 110. Furthermore, emissions from various components of the system 100 can be collected and directed towards a dust collection unit 190 (e.g., a baghouse, a scrubber, etc.). In FIG. 1, for example, the emissions from the desulfurization unit 120 and the granulator units 130 are directed to a first dust collection unit 190a, and the emissions from the torpedo prep unit 170 are directed to a second dust collection unit 190b. Each of the dust collection units 190 can filter the emissions to remove dust therefrom so that clean waste gas is sent to stacks (not shown) to be released into the atmosphere, and the removed dust can be directed to further processing.

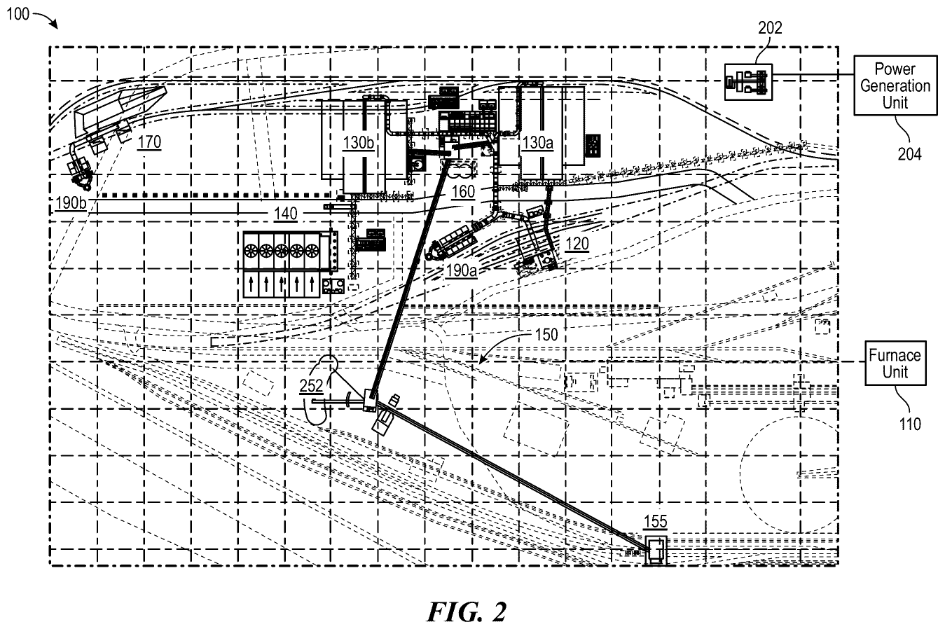

FIG. 2 is a plan view of the continuous GMU production system 100. It will be appreciated that the plan view illustrated in FIG. 2 is merely one example, and that the components of the system 100 can be arranged differently in other embodiments. As shown, the system 100 can further include an electrical building 202 and a power generation unit 204 for providing electrical power to the system 100. As discussed further herein, one or more of the components of the system 100 can be powered electrically as opposed to, e.g., hydraulically. The furnace unit 110 can be located away from many of the other components of the system 100. The torpedo car 102 or other transfer vessel (not shown) can transfer the molten iron from the furnace unit 110 to the desulfurization unit 120 along tracks illustrated in dashed lines.

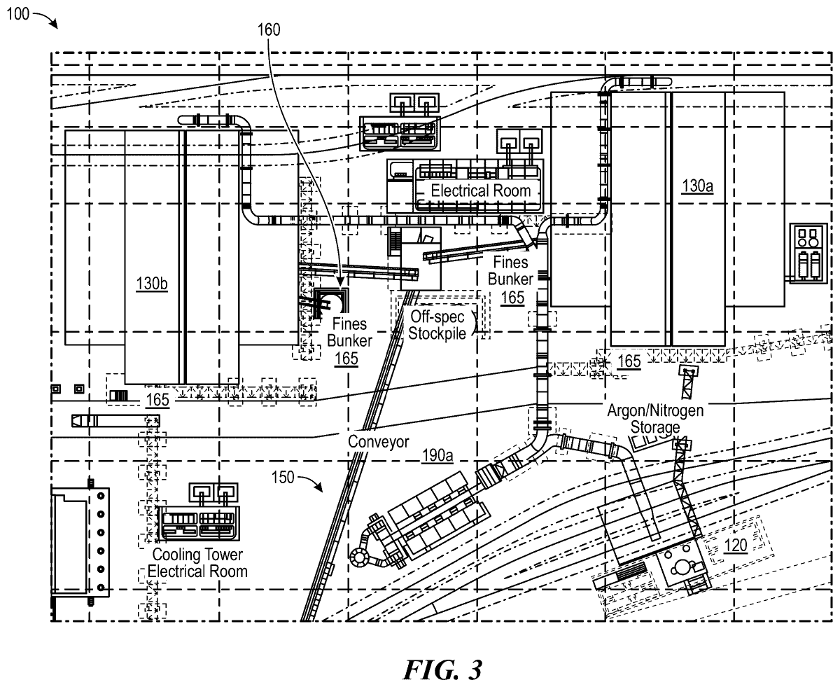

Referring momentarily to FIG. 3, which is an enlarged plan view of the system 200, the desulfurization unit 120 can desulfurize the molten iron while the molten iron remains in the torpedo car 102. Once the molten iron is desulfurized, the torpedo car 102 can continue along the tracks to the granulator units 130. The torpedo car 102 can deliver the molten iron to either of the first granulator unit 130a or the second granulator unit 130b depending on, e.g., the availability of each of the granulator units 130. The GMU produced by each of the granulator units 130 can be transferred downstream via one or more conveyor belts that form part of the product handling unit 150. The fines produced by each of the granulator units 130 can be transferred to fines bunkers located adjacent to the granulator units 130 and ultimately sent to the loadout(s) 165. As shown in FIG. 3, the first dust collection unit 190a can be connected to each of the desulfurization unit 120 and the granulator units 130 via pipes to collect emissions therefrom.

Returning to FIG. 2, the cooling system 140 can be located adjacent to the granulator units 130 to provide cooling thereto as needed. The product handling unit 150 can include a stockpile area 252 for storing GMU products. One or more conveyor belts can extend between each of the granulator units 130 and the stockpile area 252, and between the stockpile area 252 and the loadout 155. In some embodiments, the loadout 155 comprises a building at which a desired quantity of GMUs can be measured and transferred to a railcar or other transfer vehicle. In some embodiments, the GMUs is subsequently transferred to an electric arc furnace (not shown) for steel production. The torpedo car 102, after delivering the molten iron to the granulator units 130, can continue along the tracks to reach the torpedo prep unit 170. As discussed above with reference to FIG. 1, the torpedo prep unit 170 can facilitate removal of slag and/or kish from the torpedo car 102. The second dust collection unit 190b can be connected to the torpedo prep unit 170 via pipes to collect emissions therefrom.

Referring to FIGS. 1-3 together, the system 100 is expected to be able to continuously produce GMU, unlike conventional GMU production systems. First, the inclusion of the desulfurization unit 120 provides several advantages. For example, GMUs with lower sulfur content produces less slag when melted at an electric arc furnace downstream, saving associated time, costs, and energy consumption. The use of GMUs with lower sulfur content can also ease maintaining the desired chemical composition and temperature, reducing the frequency of adjustments and interruptions during the melting cycle. Lower sulfur levels can also result in less wear and tear on other components of the system, reducing maintenance needs and associated downtime.

Second, the inclusion of a plurality of granulator units 130 allows molten iron to be granulated at separate granulator units in parallel. The granulator units 130 can also serve as backups for one another in case one of the granulator units 130 is down (e.g., due to malfunctioning components, maintenance, etc.). Furthermore, in some embodiments, the various components of the granulator units 130 are modular. For example, each of the components can be easily and independently removed (e.g., for maintenance) and/or replaced (e.g., via an overhead crane) without impacting operation of the other components.

### II. Embodiments of an EAF System

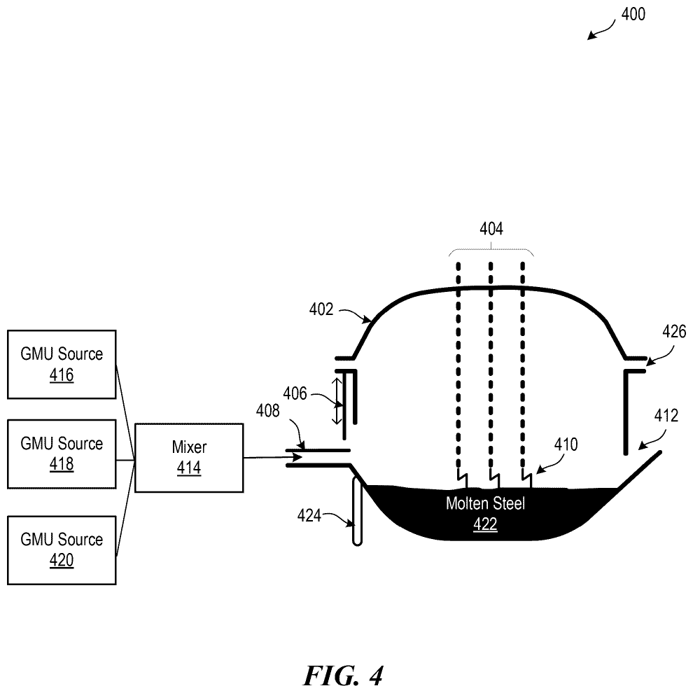

FIG. 4 is a partially schematic illustration of an EAF system 400, in accordance with embodiments of the present technology. The EAF system 400 includes a furnace shell 402, electrodes 404, a charging system, 408, a charging door 406, a tapping system 424, a spout 442, one or more gas inlets and/or outlets 426, one or more GMU sources (e.g., GMU sources 416, 418, and 420), and a mixer 414. The GMU sources 416, 418, and 420 are containers configured to store GMUs which are used as a feedstock material in the EAF system 300. In some embodiments, the GMU sources 416, 418, and 420 each include a different type of GMUs (e.g., GPI particles, granulated iron particles, or granulated steel). For example, the different types of GMUs can have different concentrations of carbon. The types of GMUs are discussed in detail with respect to section III. In some embodiments, two or more of the GMU sources 416, 418, and 420 include the same type of GMUs.

The mixer 414 is positioned to receive GMUs material from the GMU sources 416, 418, and 420 via conveyors. The GMUs can be transferred, for example, by belt, screw, vibrational and/or drag chain conveyors and/or bucket elevators. In some embodiments, the transferring of the GMUs includes vessels. The mixer 414 is configured to mix the one or more types of GMUs and provide the mixed GMUs to charging system 408 (e.g., via conveyors). The mixer 414 is an optional component of the EAF system 300. For example, when the system only includes a single GMU source, or all the GMU sources are configured to provide the same type of GMUs, the mixer is not required, and the GMUs can be transferred from the one or more GMU sources directly to the charging system.

The charging system 408 is configured to receive the GMUs and provide it to the furnace shell 102 via the charging door 406 (e.g., a sliding door). The charging system can include a continuous feeding mechanism (e.g., using conveyor belts and/or vibratory feeders), or buckets or skips, or a combination thereof. In some embodiments, the charging system 408 and/or the charging door 406 are positioned in a top portion of the furnace shell 402 so that the GMUs are provided to the furnace shell 402 from the top portion.

The furnace shell 402 is configured to receive the GMUs on the bottom of the shell. In some embodiments, the furnace shell 402 includes a refractory lining on at least a portion of its inner surface to protect the integrity of the furnace shell 402 (e.g., from erosion). The electrodes 404 (e.g., three electrodes) are positioned above the received granulated material and can be lowered to be in contact with (e.g., dipped within) the GMUs. In some embodiments, the electrodes 404 are graphite electrodes. Alternatively, the electrodes can be composite electrodes or metallic electrodes. The electrodes 404 are charged to generate electric arcs (e.g., arcs 410) between the electrodes and the GMUs inside the furnace shell 402. These arcs produce extremely high temperatures, reaching up to 6330° F., which rapidly melt the GMUs (e.g., molten steel 422). The intense heat from the electric arcs ensures efficient and uniform melting, preparing the molten steel for subsequent refining and alloying processes. The one or more gas inlets and/or outlets 426 can be used to control oxygen levels, temperature levels, and/or extracting fumes. For example, oxygen can be provided to the furnace shell 402 during melting to reduce the carbon content in the molten steel. In some embodiments, the EAF system 300 further includes a cooling system (e.g., water-cooled panels and ducts) coupled with the furnace shell 402 to absorb and dissipate the intense heat generated during the melting process.

The tapping system 424 is configured to tilt the furnace shell 402 so that the molten steel can be poured out through the tapping spout 442. Alternatively, also other types of tapping mechanisms can be applied for the removal of the molten steel, such as eccentric bottom tapping, tap hole tapping, or bottom pouring. In some embodiments, the EAF system 300 includes a stirring or mixing mechanism configured to mix the molten steel for improved uniformity.

In some embodiments, the EAF system 400 does not include any systems or components for removing impurities (e.g., de-slagging systems, desulfurization systems, oxygen blowing mechanisms). Specifically, such systems or components are not needed because the high purity GMU includes a low concentration of impurities and impurity removal is not necessary. III. Granulated Metallics Units

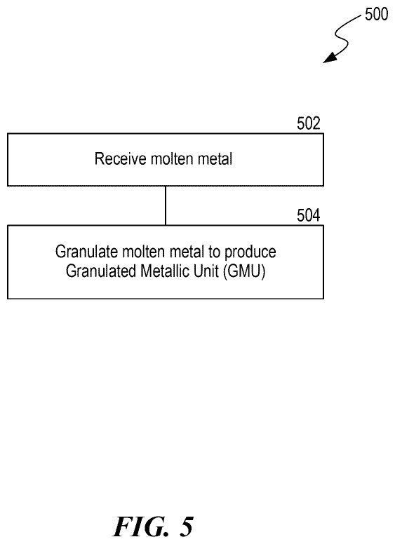

FIG. 5 is a flow diagram of a method 500 for producing a GMU, in accordance with embodiments of the present technology. The method can include receiving a molten metal (process portion 502). For example, the molten metal can be molten iron, pig iron, and/or any other molten metal described in more detail with reference to FIGS. 1-3.

The method 500 can further include granulating the molten metal to produce the GMU (process portion 504). In some embodiments, the GMU comprises a mass fraction of sulfur between 0.0001 wt. % and 0.08 wt. %, a mass fraction of phosphorous of at least 0.025 wt. %, a mass fraction of silicon between 0.35 wt. % and 1.5 wt. %, a mass fraction of manganese of at least 0.2 wt. %, a mass fraction of carbon of at least 0.8 wt. %, and/or a mass fraction of iron of at least 94.0 wt. %. For example, a granulator can granulate the molten metal to produce the GMU, as described in more detail with reference to FIGS. 1-3. In some embodiments, the GMU can be produced at a production rate of at least 250, 500, 750, 1000, 1250, 1500, 1750, or 2000 tons per day, within a range of 250 and 2000 tons per day, or any value therebetween (e.g., 253.5 tons per day, 1001 tons per day, etc.). The production process, including input materials, production rates, systems, devices, etc., is described in more detail with reference to FIGS. 1-3.

In some embodiments, the GMU comprises a mass fraction of sulfur that is at most 0.08 wt %, 0.04 wt %, 0.02 wt %, 0.01 wt %, 0.008 wt %, 0.006 wt %, 0.004 wt %, 0.002 wt %, 0.001 wt %, 0.0008 wt %, 0.0006 wt %, 0.0004 wt %, 0.0002 wt %, or 0.0001 wt %,, within a range of 0.0001 wt. % and 0.08 wt. %, 0.0001 wt. % and 0.01 wt. %, 0.0001 wt. % and 0.01 wt. %, 0.0001 wt. % and 0.008 wt. %, 0.0001 wt. % and 0.001 wt. %, or 0.0001 wt. % and 0.0008 wt. %, or any value therebetween (e.g., 0.0013 wt %, 0.024 wt %, 0.0005 wt. % and 0.08 wt. %, etc.). Lower sulfur content in the GMU can be advantageous since higher sulfur content can lead to issues during the metal processing process, such as when processing the GMU in an EAF to make steel. For example, high sulfur content can increase the slag produced during metal processing, leading to equipment corrosion in the metal processing system (e.g., the EAF) and difficulty in controlling the chemical composition of the final metal product. Furthermore, higher sulfur content can result in higher sulfur emissions, contributing to air pollution and acid rain, which have negative environmental effects. In some embodiments, the GMU is a Granulated Pig Iron (GPI). Higher sulfur content in the GPI can lead to the formation of iron sulfide (FeS) during the metal processing process. This can create weak spots in the final metal product, such as steel, making it more brittle and prone to cracking.

In some embodiments, the GMU comprises a mass fraction of carbon that is at most 0.1 wt. %, 0.5 wt. %, 1.0 wt. %, 1.5 wt. %, 2.0 wt. %, 2.5 wt. %, 3.0 wt. %, 3.5 wt. %, or 4.0 wt. %, within a range of 0.1 wt. % and 4.0 wt. %, or any value therebetween. Additionally or alternatively, the GMU can comprise a mass fraction of carbon that is at most 0.1 wt. %, 0.25 wt. %, 0.5 wt. %, 0.75 wt. %, or 1.0 wt. %, within a range of 0.1 wt. % to 1.0 wt. %, or any value therebetween. If the GMU comprises a mass fraction of carbon within a range of 0.1% and 1.0% or any value therebetween, the GMU can be GS. The GS can be used with metal processing systems such as the EAF, BOF, or LMF, and/or in foundries to produce final metal products such as steel. The GS can be desirable in steel production because it is generally more consistent in composition and more energy efficient than alternative inputs. Additionally, the GS can improve the quality and control of the final steel product.

In some embodiments, lower carbon content in the GMU increases throughput in the metal processing process. For example, lower carbon content can reduce the time spent removing excess carbon (e.g., decarburization), allowing for generally faster metal processing. Additionally, the metal processing consumes less energy by omitting the decarburization process. Lower carbon content also decreases slag formation in processing equipment (e.g., EAF, BOF, LMF, etc.), which minimizes interruptions for slag removal, allowing for more efficient metal processing, reduced wear and tear on equipment, and fewer maintenance interruptions. Furthermore, lower carbon content in the GMU generally results in lower carbon dioxide emissions during the metal processing process, reducing negative environmental effects.

The GMU can comprise a mass fraction of carbon within a range of 0.01 wt. % and 4.0 wt. % or any value therebetween, allowing the total carbon content in the metal processing process to be tunable using the GMU. For example, the GMU can be mixed with one or more additional carbon sources (e.g., low-quality iron or other materials) in the metal processing process to achieve the desired final product composition and quality. In some embodiments, using the GMU with other lower-quality carbon sources can result in an overall higher-quality final metal product. Additionally or alternatively, the GMU can be used to dilute contaminants (e.g., copper, tin, lead, zinc, nickel, chromium, molybdenum, etc.) in different metal sources and/or metal processing equipment.

The GMU can comprise (i) a mass fraction of phosphorus of at most 0.025 wt. %, 0.04 wt. %, 0.055 wt. %, 0.07 wt. %, or 0.085 wt. %, within a range of 0.025 wt. % and 0.085 wt. %, or any value therebetween, (ii) a mass fraction of silicon of at most 0.35 wt. %, 0.5 wt. %, 1.0 wt. %, 1.25 wt. %, or 1.5 wt. %, within a range of 0.35 wt. % and 1.5 wt. %, or any value therebetween, and/or (iii) a mass fraction of manganese of at most 0.2 wt. %, 0.25 wt. %, 0.3 wt. %, 0.35 wt. %, or 0.4 wt. %, within a range of 0.2 wt. % and 0.4 wt. %, or any value therebetween. Lower levels of impurities (e.g., sulfur, silicon, phosphorus, manganese, etc.) in the GMU can enhance the mechanical properties, corrosion resistance, weldability, and/or machinability of the GMU, while also reducing environmental impact and production costs in the metal processing process. Furthermore, the lower levels of impurities can result in the GMU having generally higher iron content. In some embodiments, the GMU comprises a mass fraction of iron that is at least 94.0 wt. %, 94.5 wt. %, 95.0 wt. %, 95.5 wt. %, or 96.0 wt. %, within a range of 94.0 wt. % and 96.0 wt. %, or any value therebetween. It can be advantageous to have generally higher iron content in metal processing that requires high levels of iron in the final metal product (e.g., cast iron, steel, etc.).

The composition of the GMU can affect properties such as melting point and bulk density. For example, lower levels of impurities, such as sulfur, silicon, phosphorous, manganese, etc., can lower the melting point of the GMU. Similarly, various levels of carbon in the GMU, amongst other factors, can adjust the melting point. In some embodiments, the GMU can have a melting point of at least 1100° C., 1150° C., 1200° C., 1250° C., 1300° C., 1350° C., 1400° C., 1450° C., or 1500° C., within a range of 1100° C. and 1450° C. or any value therebetween. For example, (i) a GMU having a carbon content between 2.0 wt % and 4.0 wt % can have a melting point between 1125° C. and 1175° C., (ii) a GMU having a carbon content between 1.75 wt % and 2.25 wt % can have a melting point between 1150° C. and 1200° C., (iii) a GMU having a carbon content between 1.25 wt % and 1.75 wt % can have a melting point between 1225° C. and 1375° C., and (iv) a GMU having a carbon content between 0.75 wt % and 1.25 wt % can have a melting point between 1325° C. and 1475° C. In some embodiments, the GMU has a freezing temperature of at least 1090° C., at least 1200° C., at least 1210° C., or at least 1220° C., or within a range of 1090° C. to 1230° C. Additionally, lower levels of impurities such as sulfur, silicon, phosphorus, and manganese can increase the bulk density of the GMUs, as impurities can create voids or weaken the metal structure, resulting in a less dense material. Lower carbon content can also increase the bulk density of the GMU, whereas higher carbon content generally reduces bulk density because carbon atoms are less dense than iron atoms and can create a more porous microstructure. Therefore, higher levels of iron can also increase the bulk density of the GMU. In some embodiments, the GMU has a bulk density of at least 250, 315, 380, 445, or 500 pounds per cubic foot, within a range of 250 and 500 pounds per cubic foot, or any value therebetween. The melting point and/or bulk density of the GMU can be tuned based on the metal processing process to be used and/or the desired properties of the final metal product. In some embodiments, the GMUs have a specific gravity of no more than 5.0, 5.5, 6.0, or 6.5, within a range of 5.0 to 6.5, or any value therebetween. In some embodiments, a plurality of GMUs have an angle of repose no more than 30, no more than 35, no more than 40, no more than 45, or no more than 50, within a range of 35 to 50, 40 to 50 or 45 to 50, or any value therebetween. In some embodiments, a plurality of GMUs have a uniform particle shape corresponding to an oval or round shape. For example, no more than 40%, 35%, 30%, 25%, 20%, or 15% of a plurality of GMUs have a non-round or non-oval shape or “J-hooks”.

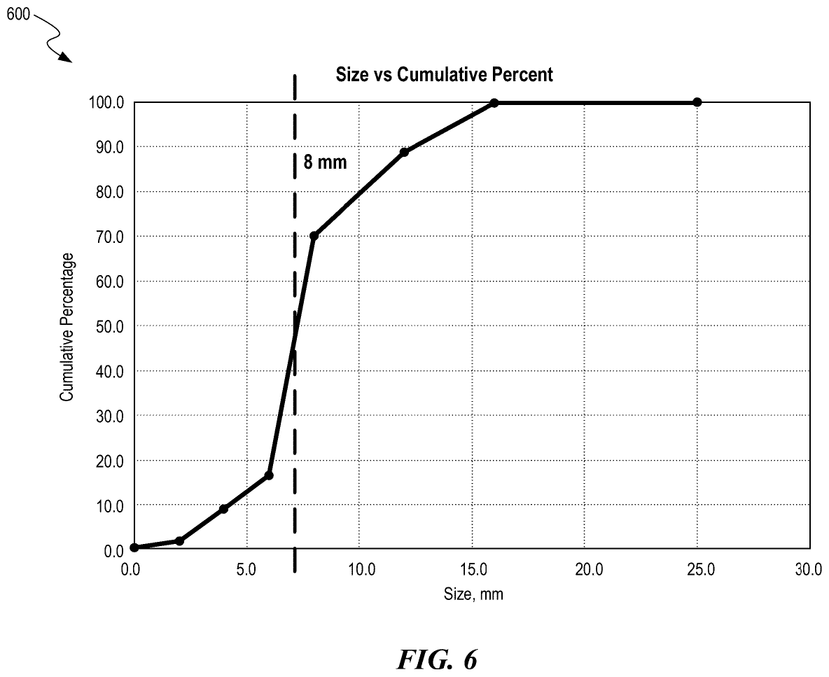

FIG. 6 is a chart 600 depicting Particle Size vs. Cumulative Percentage of GMUs, in accordance with embodiments of the present technology. The chart 500 includes a line corresponding to a particle size of 8 mm. As shown in the chart 500, the GMU reaches a cumulative weight percentage of 50% at a particle size of 8 mm. In some embodiments, the GMU can have a size distribution such that at least 50 wt. % of the GMU is at least 5 mm, 6 mm, 8 mm, 10 mm, 12 mm, 14 mm, or 16 mm, within a range of 8 mm and 16 mm, or any value therebetween. Additionally or alternatively, the GMU can have a size distribution such that at most 2.5 wt. % of the GMU is less than 1 mm, 2 mm, 3 mm, 4 mm, 5 mm, or 6 mm, within a range of 1 mm and 6 mm, or any value therebetween. In some embodiments, it is advantageous for the GMU to have a consistent particle size distribution, with at least 50 wt. % of the GMU having a particle size between 8 mm and 16 mm. Particle size consistency of the GMU can increase the permeability and uniformity in metal processing systems such as EAFs, BOFs, LMFs, and/or different furnaces. This can lead to more efficient melting and chemical reactions in creating the final metal product. Additionally, limiting the weight percentage of particles smaller than 4 mm reduces the risk of dust generation and material loss, thereby improving overall process efficiency and product quality.

In some embodiments, the GMU can have a size distribution broken down in size ranges by wt. % as depicted in Table 1 below. As shown in Table 1, the GMU can have a size distribution such that at most 0.41 wt. % of the GMU is less than 2 mm, at most 1.31 wt. % of the GMU is within a range of 2 mm and 4 mm, at most 7.24 wt. % of the GMU is within a range of 4 mm and 6 mm, and/or at most 7.53 wt. % of the GMU is within a range of 6 mm and 8 mm. Additionally or alternatively, the GMU can have a size distribution such that at least 53.46 wt. % of the GMU is within a range of 8 mm and 12 mm, at least 18.79 wt. % of the GMU is within a range of 12 mm and 16 mm, at least 10.92 wt. % of the GMU is within a range of 16 mm and 25 mm, and/or at least 0.07 wt. % of the GMU is more than 25 mm. It is worth noting that although these example wt. % and size distributions are provided, the wt. % of the size distributions can each vary by +/−10 wt. %.

TABLE 1
GMU Size Distribution

| | | | |
|---|---|---|---|
| mm | wt. % | mm | wt. % sum |

| | | | | |
|---|---|---|---|---|
| >25 | mm | 0.07 | 25 | 99.73 |
| 16-25 | mm | 10.92 | 16 | 99.66 |
| 12-16 | mm | 18.79 | 12 | 88.74 |
| 8-12 | mm | 53.46 | 8 | 69.95 |
| 6-8 | mm | 7.53 | 6 | 16.49 |
| 4-6 | mm | 7.24 | 4 | 8.96 |
| 2-4 | mm | 1.31 | 2 | 1.72 |
| <2 | mm | 0.41 | 0 | 0.41 |

As further shown in Table 1, the size distribution of the GMU can be broken down by cumulative weight percentage or “wt. % sum”. For example, 0.41 wt. % sum of the GMU is within a range 0 mm and 2 mm, 1.72 wt. % sum of the GMU is within a range of 0 mm and 4 mm, 8.96 wt. % sum of the GMU is within a range of 0 mm and 6 mm, 16.49 wt. % sum of the GMU is within a range of 0 mm and 8 mm, 69.95 wt. % sum of the GMU is within a range of 0 mm and 12 mm, 88.74 wt. % sum of the GMU is within a range of 0 mm and 16 mm, 99.66 wt. % sum of the GMU is within a range of 0 mm and 25 mm, and 99.73 wt. % sum of the GMU is within a range of 0 and over 25 mm. The wt. % sum can similarly vary by +/−10 wt. % sum, depending on the wt. % and size distributions, as described above. In some embodiments, a plurality of GMUs have an average particle size of at least 6 mm, at least 9 mm, or at least 11 mm, within a range of 6 mm to 25 mm, 9 mm to 25 mm, 11 mm to 25 mm, 14 mm to 25 mm, or any value therebetween.

The size distributions can affect the use of the GMU in the metal processing process. In some embodiments, maintaining a higher proportion of mid-sized particles (e.g., between 6 mm and 16 mm) facilitates better heat transfer and uniform distribution within the metal processing systems, optimizing energy consumption during processing. The controlled size distribution can also minimize the occurrence of blockages and/or uneven flow in the processing system, lowering the number of interruptions throughout processing. The GMU can also allow manufacturers to achieve a more consistent and high-quality output, reducing the need for reprocessing and enhancing the quality of the final metal product.

From the foregoing, it will be appreciated that, although specific embodiments of the technology have been described herein for purposes of illustration, various modifications can be made without deviating from the spirit and scope of the technology. Further, certain aspects of the new technology described in the context of particular embodiments can be combined or eliminated in other embodiments. Moreover, while advantages associated with certain embodiments of the technology have been described in the context of those embodiments, other embodiments can also exhibit such advantages, and not all embodiments need necessarily exhibit such advantages to fall within the scope of the technology. Accordingly, the disclosure and associated technology can encompass other embodiments not expressly shown or described herein. Thus, the disclosure is not limited except as by the appended claims.

### IV. Production of Molten Steel

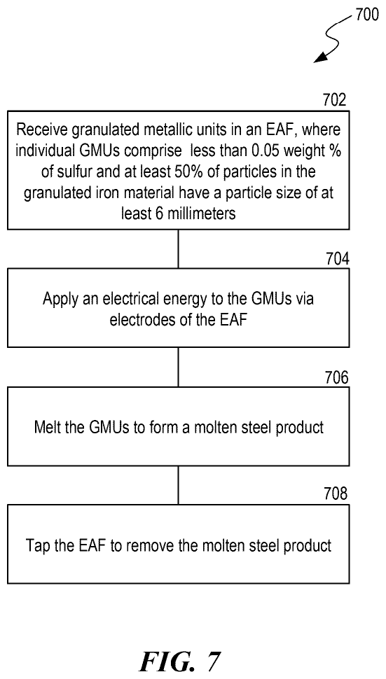

FIG. 7 is a flow diagram of a process 700 of producing steel from GMUs by an EAF system, in accordance with embodiments of the present technology. The process 700 includes receiving GMUs in an EAF (e.g., the EAF system 400 in FIG. 4) (process portion 702). The granulated iron product includes less than 0.05 wt. % of sulfur, and at least 50% of particles in the GMUs have a particle size of at least 6 mm. The process 700 includes applying electrical energy to the GMUs through electrodes (e.g., the electrodes 404 in FIG. 4) positioned above the GMUs (process portion 704). The process 700 includes melting the granulated iron product to form a molten steel product (e.g., molten steel 422 in FIG. 4) (process portion 706). The process 700 also includes tapping the EAF to remove the molten steel product from the EAF (e.g., tapping by a tapping system 424 so that the molten steel 422 exits the furnace shell 402 through the spout 412) (process portion 708).

In some embodiments, the GMU source is a first GMU source (e.g., the GMU source 416 in FIG. 4) and the GMUs is a first GMUs. In such embodiments, the process 700 can further include receiving a second GMUs from a second GMU source (e.g., the GMU source 418 in FIG. 4). The process 700 can include receiving the first GMUs from the first GMU source and the second GMUs from the second GMU source by a mixer (e.g., the mixer 414 in FIG. 4). The first and second GMUs can include GPI particles having a concentration of more than 4 wt. % of carbon, granulated iron particles having a concentration of 1 to 4 wt. % of carbon, and/or granulated steel particles having a concentration of less than 1 wt. % of carbon. The amount of the first GMUs received by the mixer can be the same, or different, than the amount of the second GMUs (e.g., 10%, 25%, 50%, 75%, or 90%) The process 700 can include mixing the first GMUs and the second GMUs and provide the mixed first and the second GMUs to the furnace shell. In some embodiments, the process 700 includes additional steps not illustrated in FIG. 7. The additional steps may come before, after, or between blocks 702 and 708.

### CONCLUSION

It will be apparent to those having skill in the art that changes may be made to the details of the above-described embodiments without departing from the underlying principles of the present technology. In some cases, well known structures and functions have not been shown or described in detail to avoid unnecessarily obscuring the description of the embodiments of the present technology. Although steps of methods may be presented herein in a particular order, alternative embodiments may perform the steps in a different order. Similarly, certain aspects of the present technology disclosed in the context of particular embodiments can be combined or eliminated in other embodiments. Furthermore, while advantages associated with certain embodiments of the present technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein, and the invention is not limited except as by the appended claims.

Throughout this disclosure, the singular terms “a,” “an,” and “the” include plural referents unless the context clearly indicates otherwise. The term “comprising,” “including,” and “having” should be interpreted to mean including at least the recited feature(s) such that any greater number of the same feature and/or additional types of other features are not precluded.

Reference herein to “one embodiment,” “an embodiment,” “some embodiments” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

Unless otherwise indicated, all numbers expressing concentrations and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present technology. At the very least, and not as an attempt to limit the application of the doctrine of equivalents to the scope of the claims, each numerical parameter should at least be construed in light of the number of reported significant digits and by applying ordinary rounding techniques. Additionally, all ranges disclosed herein are to be understood to encompass any and all subranges subsumed therein. For example, a range of “1 to 10” includes any and all subranges between (and including) the minimum value of 1 and the maximum value of 10, i.e., any and all subranges having a minimum value of equal to or greater than 1 and a maximum value of equal to or less than 10, e.g., 5.5 to 10.

The disclosure set forth above is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

The present technology is illustrated, for example, according to various aspects described below as numbered clauses or embodiments (1, 2, 3, etc.) for convenience. These are provided as examples and do not limit the present technology. It is noted that any of the dependent clauses can be combined in any combination, and placed into a respective independent clause.
1. A method for producing steel from granulated metallic units using an electric arc furnace (EAF), the method comprising:
   receiving granulated metallic units (GMUs) in an EAF, wherein the GMUs comprise no more than 0.05 wt. % of sulfur and at least 50% of the GMUs have a particle size of at least 6 millimeters;
   applying electrical energy to the GMUs via electrodes;
   melting the GMUs to form a molten steel product; and
   tapping the EAF to remove the molten steel product.
1. The method of any of the clauses herein, wherein the GMUs comprises no more than 0.01 wt. % of sulfur.
2. The method of any of the clauses herein, wherein the GMUs comprise between 0.0001 wt. % and 0.01 wt. % of sulfur and between 0.8 wt. % and 4.0 wt. % of carbon.
3. The method of any of the clauses herein, wherein the GMUs comprise between 0.0001 wt. % and 0.01 wt. % of sulfur and no more than 2.0 wt. % of carbon.
4. The method of any of the clauses herein, wherein the GMUs comprise granulated pig iron (GPI) particles and at least 4 wt. % of carbon.
5. The method of any of the clauses herein, wherein the GMUs comprise 1 wt. % to 4 wt. % of carbon.
6. The method of any of the clauses herein, wherein the GMUs comprise granulated steel particles and no more than 1 wt. % of carbon.
7. The method of any of the clauses herein, wherein the GMUs comprises 94 wt. % to 96 wt. % of iron.
8. The method of any of the clauses herein, wherein the GMUs comprise 0.01 wt. % to 0.1 wt. % of phosphorus, 0.1 wt. % to 2 wt. % of silicon, and 0.1 wt. % to 1.0 wt. % of manganese.
9. The method of any of the clauses herein, wherein at least 50% of particles of the GMUs have a particle size between 6 millimeters and 10 millimeters.
10. The method of any of the clauses herein, wherein the molten steel product has a sulfur concentration below or equal to 0.05 wt. %.
11. The method of any of the clauses herein, further comprising producing slag as a by-product, wherein the produced slag is less than 10 wt. % of the produced molten steel product.
12. The method of any of the clauses herein, wherein an average particle size of the GMUs is between 6 to 25 mm.
13. An electric arc furnace (EAF) system for producing steel from granulated metal units (GMUs), the EAF system comprising:
   a furnace shell positioned to receive a plurality of the GMUs, wherein individual GMUs comprise:
      a mass fraction of phosphorous of at least 0.025 wt. %;
      a mass fraction of silicon between 0.325 wt. % and 1.5 wt. %;
      a mass fraction of manganese of at least 0.2 wt. %;
      a mass fraction of carbon of at least 0.8 wt. %;
      a mass fraction of sulfur between 0.0001 wt. % and 0.08 wt. %; and
      a mass fraction of iron of at least 94.0 wt. %;
   electrodes configured to conduct electrical energy into the furnace shell to melt the GMUs to form a molten steel product; and
   a tapping system configured to remove the molten steel product from the furnace shell.
14. The system of any of the clauses herein, wherein the GMUs comprises no more than 0.01 wt. % of sulfur.
15. The system of any of the clauses herein, wherein the GMUs comprise between 0.0001 wt. % and 0.01 wt. % of sulfur and between 0.8 wt. % and 4.0 wt. % of carbon.
16. The system of any of the clauses herein, wherein the GMUs comprise between 0.0001 wt. % and 0.01 wt. % of sulfur and no more than 2.0 wt. % of carbon.
17. The system of any of the clauses herein, wherein at least 50% of particles of the GMUs have a particle size between 6 millimeters and 10 millimeters.
18. The system of any of the clauses herein, wherein an average particle size of the GMUs is between 6 to 25 mm.
19. The system of any of the clauses herein, further comprising a charging system positioned to receive the GMUs from a GMU source and charge the GMUs to the furnace shell.
20. A method for producing steel from granulated iron material using an electric arc furnace (EAF), the method comprising:
   receiving granulated iron in an EAF, wherein the granulated iron material comprises less than or equal to 0.05 wt. % of sulfur;
   applying electrical energy to the granulated iron via electrodes positioned above the received granulated iron material;
   melting the granulated iron material to form a molten steel product; and
   tapping the EAF to remove the molten steel product from the EAF.
21. The method of any one of the clauses herein, wherein the granulated iron material comprises less than or equal to 0.01 wt. %, less than 0.005 wt. %, less than 0.003 wt. % of sulfur.
22. The method of any one of the clauses herein, wherein the granulated iron material comprises 0.0001 wt. % to 0.05 wt. %, 0.0001 wt. % to 0.02 wt. %, or 0.0001 wt. % to 0.01 wt. % of sulfur.
23. The method of any one of the clauses herein, wherein the granulated iron material comprises between 0.0001 wt. % and 0.05 wt. %; of sulfur.
24. The method of any one of the clauses herein, wherein the granulated iron material comprises at most 0.0005 wt. %, 0.001 wt. %, 0.02 wt. %, 0.04 wt. %, or 0.05 wt. %.
25. The method of any one of the clauses herein, wherein the granulated iron material comprises more than 4 wt. % of carbon.
26. The method of any one of the clauses herein, wherein the granulated iron material comprises 1 wt. % to 4 wt. % of carbon.
27. The method of any one of the clauses herein, wherein the granulated iron material comprises less than 1 wt. % of carbon.
28. The method of any one of the clauses herein, wherein the granulated iron material comprises 0.1 wt. % to 2 wt. % of carbon.
29. The method of any one of the clauses herein, wherein the granulated iron material comprises granulated pig iron (GPI) particles having a concentration of more than 4 wt. % of carbon, granulated iron particles having a concentration of 1 to 4 wt. % of carbon, or granulated steel particles having a concentration of less than 1 wt. % of carbon.
30. The method of any one of the clauses herein, wherein the granulated iron material comprises a mixture of two or more of granulated pig iron (GPI) particles having a concentration of more than 4 wt. % of carbon, granulated iron particles having a concentration of 1 to 4 wt. % of carbon, and granulated steel particles having a concentration of less than 1 wt. % of carbon.
31. The method of any one of the clauses herein, wherein the granulated iron material comprises 94 wt. % to 96 wt. % of iron.
32. The method of any one of the clauses herein, wherein the granulated iron comprises 94 wt. % to 96 wt. % of iron and less than or equal to 0.01 wt. %, less than 0.005 wt. %, less than 0.003 wt. % of sulfur.
33. The method of any one of the clauses herein, wherein the granulated iron comprises 94 wt. % to 96 wt. % of iron, less than or equal to 0.01 wt. %, less than 0.005 wt. %, less than 0.003 wt. % of sulfur and more than 4 wt. % of carbon.
34. The method of any one of the clauses herein, wherein the granulated iron comprises 94 wt. % to 96 wt. % of iron, less than or equal to 0.01 wt. %, less than 0.005 wt. %, less than 0.003 wt. % of sulfur and 1 wt. % to 4 wt. % of carbon.
35. The method of any one of the clauses herein, wherein the granulated iron comprises 94 wt. % to 96 wt. % of iron, less than or equal to 0.01 wt. %, less than 0.005 wt. %, less than 0.003 wt. % of sulfur and less than 1 wt. % of carbon.
36. The method of any one of the clauses herein, wherein the granulated iron material comprises 0.01 wt. % to 0.1 wt. % of phosphorus, 0.1 wt. % to 2 wt. % of silicon, and 0.1 wt. % to 1.0 wt. % of manganese.
37. The method of any one of the clauses herein, wherein at least 50% of particles in the granulated iron material have a particle size of at least 6 millimeters.
38. The method of any one of the clauses herein, wherein at least 50% of particles in the granulated iron material have a particle size between 6 and 16 millimeters.
39. The method of any one of the clauses herein, wherein at least 50% of particles in the granulated iron material have a particle size between 6 and 12 millimeters.
40. The method of any one of the clauses herein, wherein at least 50% of particles in the granulated iron material have a particle size between 6 and 10 millimeters.
41. The method of any one of the clauses herein, wherein at most 2.5% of particles in the granulated iron material have a particle size of less than 4 millimeters.
42. The method of any of the clause herein, wherein the size distribution of the granulated iron material is such that at least 30 wt. %, 40 wt. %, 50 wt. %, or 60 wt. % of the granulated iron material has a particle size of at least 6, 7, 8, 9, 10, 11, or 12 millimeters.
43. The method of any of the clause herein, wherein the size distribution of the granulated iron material is such that at least 30 wt. %, 40 wt. %, 50 wt. %, or 60 wt. % of the granulated iron material has a particle size of at least 6, 6.5, 7, 7.5, 8, 8.5, 9, 9.5, or 10 millimeters.
44. The method of any one of the clauses herein, wherein the molten steel product has a sulfur concentration below or equal to 0.05 wt. % without performing desulfurization during the melting or the tapping.
45. The method of any one of the clauses herein, wherein the molten steel product has a sulfur concentration below or equal to 0.05 wt. % and a time for producing the molten steel product is 10 min to 30 min less than when producing a molten steel product of a same sulfur concentration from a granulated iron including more than 0.05 wt. % of sulfur.
46. The method of any one of the clauses herein, further comprising producing slag as a by-product, wherein an among of the produced slag is less than 10%, less than 5%, or less than 1% of an amount of the produced molten steel product without performing de-slagging.
47. The method of any one of the clauses herein, wherein the molten steel product has 0.1 wt. % to 2 wt. % of carbon.
48. The method of any one of the clauses herein, wherein the molten steel product has 0.05 wt. % to 0.25 wt. %, 0.25 wt. % to 0.6 wt. %, 0.06 wt. % to 1.5 wt. %, or 1.5 wt. % to 2.0 wt. % of carbon.
49. The method of any one of the clauses herein, wherein the granulated iron material source is a first granulated iron material source and the granulated iron material is a first granulated iron material, and the method further comprises:
   receiving a second granulated iron material from a second granulated iron material source;
   receiving, by a mixer, the first granulated iron material from the first granulated iron material source and the second granulated iron material from the second granulated iron material source; and
   mixing the first granulated iron material and the second granulated iron material and provide the mixed first and the second granulated iron material to the furnace shell.
50. The method of any one of the clauses herein, wherein the granulated iron material has an average particle size of at least 6 mm, 9 mm, or 11 mm.
51. The method of any one of the clauses herein, wherein the granulated iron material has an angle of repose no more than 30, 35, 40, 45, or 50.
52. The method of any one of the clauses herein, wherein no more than 30%, 25%, 20% or 15% of the granulated iron material has a non-round or non-oval shape.
53. The method of any one of the clauses herein, wherein the granulated iron material has a specific gravity of no more than 5.0, 5.5, 6.0, or 6.5.
54. The method of any one of the clauses herein, wherein the granulated iron material has a freezing temperature of at least 1090° C., at least 1200° C., at least 1210° C., or at least 1220° C., or within a range of 1090° C. to 1230° C.
55. The method of any one of the clauses herein, wherein the granulated iron material has of at least 1100° C., 1150° C., 1200° C., 1250° C., 1300° C., 1350° C., 1400° C., 1450° C., or 1500° C.
56. A method for producing steel from granulated iron material using an electric arc furnace (EAF), the method comprising:
   receiving granulated iron in an EAF, wherein the granulated iron material comprises 0.1 wt. % to 2 wt. % of carbon;
   applying electrical energy to the granulated iron via electrodes positioned above the received granulated iron material;
   melting the granulated iron material to form a molten steel product; and
   tapping the EAF to remove the molten steel product from the EAF.
57. A molten steel product produced from granulated iron material by a method comprising:
   receiving granulated iron in an EAF, wherein the granulated iron material comprises less than or equal to 0.05 wt. % of sulfur;
   applying electrical energy to the granulated iron via electrodes positioned above the received granulated iron material;
   melting the granulated iron material to form the molten steel product, wherein the molten steel product has a concentration below or equal to 0.05 wt. % of sulfur.
58. The molten steel product of any one of the clauses herein, wherein the molten steel product has a sulfur concentration below or equal to 0.05 wt. % and a time for producing the molten steel product is 10 min to 30 min less than when producing a molten steel product of a same sulfur concentration from a granulated iron including more than 0.05 wt. % of sulfur.
59. The molten steel product of any one of the clauses herein, further comprising producing slag as a by-product, wherein an among of the produced slag is less than 10%, less than 5%, or less than 1% of an amount of the produced molten steel product without performing de-slagging.
60. The molten steel product of any one of the clauses herein, wherein the molten steel product has 0.1 wt. % to 2 wt. % of carbon.
61. The molten steel product of any one of the clauses herein, wherein the molten steel product has 0.05 wt. % to 0.25 wt. %, 0.25 wt. % to 0.6 wt. %, 0.06 wt. % to 1.5 wt. %, 0.1 wt. % to 2 wt. %, or 1.5 wt. % to 2.0 wt. % of carbon.
62. An electric arc furnace (EAF) system for producing steel from granulated iron material, the EAF system comprising:
   a GMU source comprising granulated iron material, wherein the granulated iron material comprises less than or equal to 0.05 wt. % of sulfur;
   a furnace shell positioned to receive the granulated iron material from the GMU source;
   a set of graphite electrodes positioned above the received granulated iron material and configured to conduct electrical energy into the furnace shell to melt the granulated iron material to form a molten steel product; and
   tapping system configured to tap the furnace shell to remove the molten steel product from the EAF system.
63. The EAF system of any one of the clauses herein, wherein the GMU source is a first GMU source and the granulated iron material is a first granulated iron material, and the system further comprises:
   a second GMU source comprising second granulated iron material; and
   a mixer positioned to receive the first granulated iron material from the first GMU source and the second granulated iron material from the second GMU source and the mixer is configured to mix the first granulated iron material and the second granulated iron material and provide the mixed first and the second granulated iron material to the furnace shell.
64. The EAF system of any one of the clauses herein, further comprising a charging system positioned to receive the granulated iron material from the GMU source and charge the granulated iron material to the furnace shell.
65. The EAF system of any one of the clauses herein, further comprising a cooling system coupled with the furnace shell.
66. The EAF system of any one of the clauses herein, wherein the furnace shell includes a refractory material lining.
67. The EAF system of any one of the clauses herein, further comprising a tapping system configured to tilt the furnace shell to remove the molten steel from the furnace shell through a spout.
68. The EAF system of any one of the clauses herein, wherein the EAF system does not include a desulfurization system.

I/We claim:

1. A method for producing steel from granulated metallic units using an electric arc furnace (EAF), the method comprising:
receiving granulated metallic units (GMUs) in an EAF, wherein the GMUs comprise no more than 0.05 wt. % of sulfur and at least 50% of the GMUs have a particle size of at least 6 millimeters;
applying electrical energy to the GMUs via electrodes;
melting the GMUs to form a molten steel product; and
tapping the EAF to remove the molten steel product.

1. The method of claim 1, wherein the GMUs comprises no more than 0.01 wt. % of sulfur.

2. The method of claim 1, wherein the GMUs comprise between 0.0001 wt. % and 0.01 wt. % of sulfur and between 0.8 wt. % and 4.0 wt. % of carbon.

3. The method of claim 1, wherein the GMUs comprise between 0.0001 wt. % and 0.01 wt. % of sulfur and no more than 2.0 wt. % of carbon.

4. The method of claim 1, wherein the GMUs comprise granulated pig iron (GPI) particles and at least 4 wt. % of carbon.

5. The method of claim 1, wherein the GMUs comprise 1 wt. % to 4 wt. % of carbon.

6. The method of claim 1, wherein the GMUs comprise granulated steel particles and no more than 1 wt. % of carbon.

7. The method of claim 1, wherein the GMUs comprises 94 wt. % to 96 wt. % of iron.

8. The method of claim 1, wherein the GMUs comprise 0.01 wt. % to 0.1 wt. % of phosphorus, 0.1 wt. % to 2 wt. % of silicon, and 0.1 wt. % to 1.0 wt. % of manganese.

9. The method of claim 1, wherein at least 50% of particles of the GMUs have a particle size between 6 millimeters and 10 millimeters.

10. The method of claim 1, wherein the molten steel product has a sulfur concentration below or equal to 0.05 wt. %.

11. The method of claim 1, further comprising producing slag as a by-product, wherein the produced slag is less than 10 wt. % of the produced molten steel product.

12. The method of claim 1, wherein an average particle size of the GMUs is between 6 to 25 mm.

13. An electric arc furnace (EAF) system for producing steel from granulated metal units (GMUs), the EAF system comprising:
a furnace shell positioned to receive a plurality of the GMUs, wherein individual GMUs comprise:
a mass fraction of phosphorous of at least 0.025 wt. %;
a mass fraction of silicon between 0.325 wt. % and 1.5 wt. %;
a mass fraction of manganese of at least 0.2 wt. %;
a mass fraction of carbon of at least 0.8 wt. %;
a mass fraction of sulfur between 0.0001 wt. % and 0.08 wt. %; and
a mass fraction of iron of at least 94.0 wt. %;
electrodes configured to conduct electrical energy into the furnace shell to melt the GMUs to form a molten steel product; and
a tapping system configured to remove the molten steel product from the furnace shell.

14. The system of claim 14, wherein the GMUs comprises no more than 0.01 wt. % of sulfur.

15. The system of claim 14, wherein the GMUs comprise between 0.0001 wt. % and 0.01 wt. % of sulfur and between 0.8 wt. % and 4.0 wt. % of carbon.

16. The system of claim 14, wherein the GMUs comprise between 0.0001 wt. % and 0.01 wt. % of sulfur and no more than 2.0 wt. % of carbon.

17. The system of claim 14, wherein at least 50% of particles of the GMUs have a particle size between 6 millimeters and 10 millimeters.

18. The system of claim 14, wherein an average particle size of the GMUs is between 6 to 25 mm.

19. The system of claim 14, further comprising a charging system positioned to receive the GMUs from a GMU source and charge the GMUs to the furnace shell.
